(19) United States
(12) Patent Application Publication
(10) Pub. No.: US 2005/0185809 A1
(43) Pub. Date: Aug. 25, 2005

(54) Audio frequency speaker

(75) Inventor: Emanuele Bianchini, Winchester, MA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: VIBRATION-X di Bianchini Emanuele e C. Sas

(21) Appl. No.: 11/063,522

(22) Filed: Feb. 23, 2005

Related U.S. Application Data
(60) Provisional application No. 60/547,209, filed on Feb. 24, 2004.

(51) Int. Cl. H04R 25/00; H04R 9/06; H04R 11/02

(52) U.S. Cl. 381/190; 381/406; 381/423

(57) ABSTRACT

An improved audio frequency speaker comprises a speaker cone suspended for movement to generate air displacement, a voice coil having at least one winding attached to the cone and a magnet having a magnetic field. The magnet is located such that at least a portion of the coil is within the magnetic field to thereby cause the coil and the cone to move when a current from an audio frequency drive signal flows through the coil winding. At least one piezoelectric actuator is secured to the cone and is adapted to receive the audio frequency drive signal. The at least one piezoelectric actuator moves the cone, at least at higher order frequencies of the audio frequency range, to thereby enhance the performance range of the speaker at the higher order frequency so that a single speaker covers the entire audio frequency range.

### CROSS-REFERENCE TO RELATED APPLICATIONS

This application claims priority from U.S. Provisional Patent Application No. 60/547,209 filed Feb. 24, 2004 and entitled “Loud Speaker Including A Piezoelectric Actuator,” the entire subject matter of which is hereby incorporated herein by reference.

### BACKGROUND OF THE INVENTION

The present invention relates to audio frequency speakers and, more particularly, to an improved audio frequency speaker for extending the frequency range of a voice coil speaker (woofer or mid range) by using one or more piezoelectric actuators mounted to one or more components of the speaker.

Sound system designers have historically used electromagnetic voice coil transducers or speakers to generate air displacement. FIG. 1 is a schematic view of a typical prior art transducer 10 comprised of a suspended speaker cone 12 that is moved in and out by an attached voice coil 14 which moves through the magnetic field of a magnet 16 when current travels through the windings of the coil 14. Such transducers are usually placed in a housing or acoustic baffle such as a sealed or ported box. The baffle keeps the pressure generated on the backside of the cone 12 from canceling out the pressure on the front side of the cone 12, especially at low frequencies where the air molecules would otherwise slosh back and forth around the edges of the cone 12. Without such a baffle, the sloshing tends to greatly reduce the sound level in the transducer's low frequency range and also causes the transducer to radiate the pressure wave in a more directional or beam-like manner, similar to that of a flashlight.

When operating at low frequencies, the cone 12 of such prior art transducers tends to maintain its shape and move in and out much like a rigid piston. As the driving frequency increases, the cone 12 eventually reaches a frequency at which it begins to breakup or resonate in various structural modes. Such speakers which are driven within the breakup region have poor quality sound because the resulting resonances create audible peaks and dips in the frequency response. One method of dealing with such breakup problems is to mechanically damp out the resonant modes to minimize their influence. Another method is to stop driving the transducer 10 within its breakup region and instead cross over to another, smaller transducer (not shown) which is operating below its own breakup frequency. This approach creates multi-transducer speaker assemblies that may include woofers (for low frequencies), mid range transducers (for mid frequencies) and tweeters (for high frequencies). In a premium sound system, a woofer and a tweeter are two physically separate components. The woofer covers the low frequency range (generally up to 5 KHz) and the tweeter covers the high frequency range (typically 5KHz and above). When space is a concern, the tweeter cone may be located on the center of the woofer cone, typically where the dust cap 18 is located. Although this method permits multi transducer assemblies to fit within a smaller housing, the speaker system is made up of two independent devices. Such speaker assemblies typically require additional electronic crossover components to direct the drive signal at various frequencies to the specific transducers that handle them. Such speaker assemblies also are more prone to peaks or dips in the frequency response in the crossover region where two transducers may be operating at the same output level.

Piezoelectric materials are materials which are capable of converting electrical energy into mechanical energy and vice versa. Such materials can be used as sensors (mechanical input-electrical output), as actuators (electrical input-mechanical output) or as vibration control devices (active when power is supplied to the system and passive when the energy generated is dissipated by an electrical component). If a piezoelectric actuator is affixed to a structure and the piezoelectric actuator is driven by an audio frequency drive signal, the structure moves according to the input signal and the dynamic response of the structure itself. The sound quality of a piezoelectric actuator speaker is typically limited by the shape and size of the structure to which the piezoelectric material is attached. For this reason, piezoelectric materials have been used in the past as buzzers or as single frequency alert devices. In such devices the piezoelectric actuator excites the structure at its resonance frequency generating a tone or limited frequency band.

There have been some attempts at using piezoelectric electric material as a full range speaker but the size and rigidity of the structure have presented significant hurdles. In order to achieve a low frequency range the structure itself has to be large and very soft so that its first response is below the subwoofer range (20 Hz or so).

Unlike conventional loud speakers, piezoelectric speakers operate entirely within the breakup mode region. The fundamental frequency of the driven structure defines the lowest frequency at which the appreciable displacement is generated by the piezoelectric speaker. The objective in designing piezoelectric speakers is to make sure that there are enough structural vibration modes which are closely spaced to result in a smooth frequency response across the entire operating frequency (i.e. no large peaks or dips in the frequency response where resonances either are not present or are not over abundant). The complex surface displacement of the driven structure resulting from the superposition of several vibration modes at a given frequency causes the pressure wave to radiate away from the structure in very complex, multi-beam patterns. While some listeners notice no appreciable difference in this type of radiation, other say that this complex radiation sounds more ambient or spacious than traditional speakers.

The present invention comprises an improved audio frequency speaker extending the range of a typical voice coil speaker by using one or more piezoelectric actuators. The piezoelectric actuators are located on the speaker cone 12 or a panel-like component of the speaker, such as the dust cover 18. The piezoelectric actuators are driven by the same electrical drive signal that is delivered to the voice coil 14. The piezoelectric material converts the electrical input of the drive signal to strain which actuates the cone 12 of the speaker. The piezoelectric actuators excite the cone 12 at the high frequency range since they are more efficient at such high frequencies and generate sound by moving the cone 12 at the higher order frequencies. There is no need for special electrical circuitry or for a crossover network in order to achieve such a driving condition because the present invention uses the main feature of each driving actuator (low frequency for the voice coil and high frequency for the piezoelectric actuator). Additionally, the piezoelectric actuators can be integrated into the cone material either as fibers or as piezoelectric plates. This technique not only allows for an integrated, low cost design but it also provides great flexibility in the frequency ranges to be covered. Additionally, speakers using the disclosed technique may be consistency manufactured so as to provide a repeatable frequency response.

### BRIEF SUMMARY OF THE INVENTION

An improved audio frequency speaker comprises a speaker cone suspended for movement to generate air displacement, a voice coil having at least one winding attached to the cone and a magnet having a magnetic field. The magnet is located such that at least a portion of the coil is within the magnetic field to thereby cause the coil and the cone to move when a current from an audio frequency drive signal flows through the coil winding. The improvement comprises at least one piezoelectric actuator secured to the cone and adapted to receive the audio frequency drive signal. The at least one piezoelectric actuator moves the cone at least at higher order frequencies of the audio frequency range to thereby enhance the performance range of the speaker at the higher order frequencies so that a single speaker covers the entire audio frequency range.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a functional schematic view of a typical prior art audio frequency speaker;

FIG. 2 is a schematic view similar to that of FIG. 1 showing an improved audio frequency speaker in accordance with a first preferred embodiment of the present invention;

FIG. 3 is a top perspective view of a speaker of the type shown in FIG. 2; and

FIG. 4 is a graphical representation of the response of the speaker shown in FIG. 2 as a function of different frequencies within the audio frequency range.

### DETAILED DESCRIPTION OF THE INVENTION

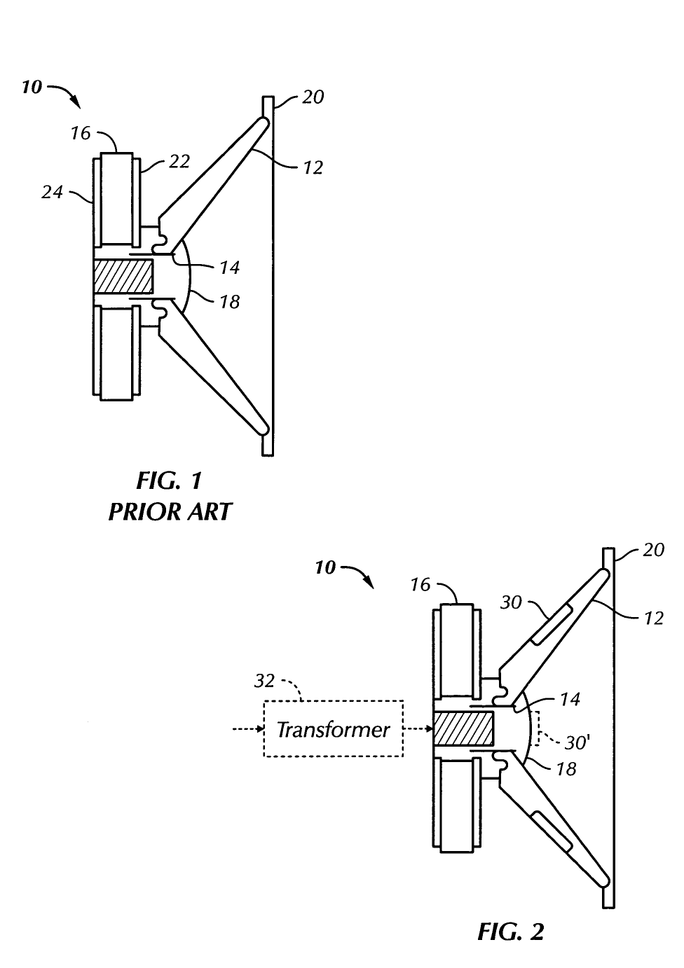

Referring now to the drawings, wherein the same reference numerals are used to designate the same components throughout the several figures, there is shown in FIG. 1 a typical prior art audio frequency transducer or speaker 10 of the type typically referred to as a woofer or mid range speaker. The speaker 10 includes a speaker cone 12 typically fabricated of a relatively flexible material such as a composite material, cardboard/paper, a polymeric material, metal or any other suitable material known to those of ordinary skill in the art. The cone 12 is suspended within a housing or surround 20, only a portion of which is shown on FIG. 1. The innermost or smaller end of the cone 12 is attached to a voice coil 14 in a manner well known to those of ordinary skill in the art. The voice coil 14, which is of a type well known in the art, includes one or more coil windings (not shown) which are electrically connected to an audio amplifier (not shown) such as a radio receiver, home theater device, car audio amplifier or the like which generates and outputs an audio frequency drive signal resulting in current flowing through the windings of the coil 14. It will be appreciated by those of ordinary skill in the art that the source of the audio frequency drive signal is immaterial to the present invention.

The speaker 10 further comprises a magnet 16 also of a well know type which establishes a magnetic field. At least a portion of the coil 14 is located within the magnetic field established by the magnet 16. In this manner, when current from an audio frequency drive signal flows through the windings of the coil 14 the magnetic field causes the coil 14 and the cone 12 to move and to thereby generate acoustic waves.

The speaker 10 may also include additional typical components such as a dust cap 18 which covers at least the coil 14 of the speaker 10. Front and back plates 22 and 24 may also be provided on opposite sides of the magnet 16. If desired, the speaker 10 may be placed in an acoustic baffle or housing 20 (only partially shown) in order to improve performance and the appearance of the speaker 10. Other additional components known to those of ordinary skill in the art may also be included with the speaker 10.

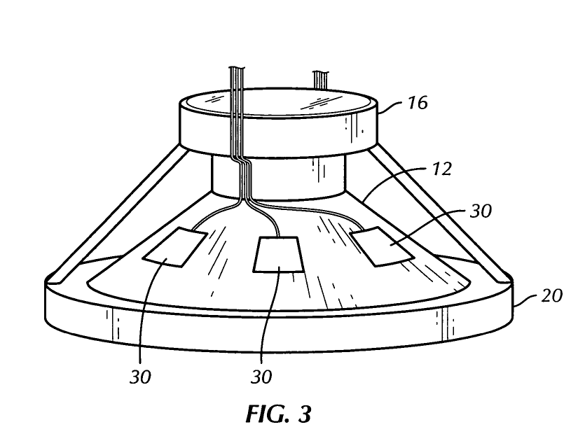

As discussed above, the present invention is an improvement on the prior art speaker 10 as shown in FIG. 1 which provides a single cone full range speaker. Referring now to FIGS. 2 and 3, in the first preferred embodiment of the present invention, the improvement comprises providing at least one piezoelectric actuator 30 which is secured to the speaker cone 12. In the embodiment shown in FIGS. 2 and 3, the piezoelectric actuator 30 is bonded to one surface of the speaker cone 12, in the illustrated embodiment the back or outer surface using any suitable bonding agent. It will be appreciated by those of ordinary skill in the art that the piezoelectric actuator 30 may alternatively be bonded to the opposite surface of the cone 12 if desired. As a further alternative, the piezoelectric actuator 30 may be embedded into or integrated into the material of the speaker cone 12. The piezoelectric actuator 30 may comprise a piezoceramic plate such as a bare piezoceramic plate or a packaged piezoceramic plate. Alternatively, and particularly if the piezoelectric actuator 30 is integrated into the material of the speaker cone 12, the piezoelectric actuator 30 may be a piezoelectric fiber. It will be appreciated by those of skill in the art that the piezoelectric actuator 30 may take on many different forms currently known or which may here after become available. The particular form of piezoelectric actuator 30 which is employed may depend upon the environmental conditions with which the speaker 10 may be used, the manufacturing techniques employed for producing the speaker cone 12, the particular speaker configuration and other factors known to those of ordinary skill in the art. It should be clear that the particular form of the piezoelectric actuator 30 should not be considered to be a limitation on the present invention. The piezoelectric actuator 30 is secured to the speaker cone 12 so that actuation of the piezoelectric actuator 30 by a audio frequency drive signal imparts mechanical motion to the speaker cone 12. The amount of electrical energy that is directly transformed by the piezoelectric actuator 30 into mechanical motion of the speaker cone 12, (typically referred to as actuation authority) may be maximized if the piezoelectric actuator 30 is located away from the neutral axis so that the piezoelectric actuator 30 can impart a larger bending moment to the speaker cone 12. The neutral axis is defined as the location, through the thickness, at which a bending force applied to the speaker cone 12 will not produce any displacement. If the piezoelectric actuator 30 is centrally located through the thickness of the cone 12, its actuation authority will be minimized since its location is coincident with the neutral axis. The specific location at which the piezoelectric actuator 30 is secured to the speaker cone 12 is established so that the desired performance in the higher audio frequency range can be obtained. Preferably, the stiffness of the piezoelectric actuator 30 matches the stiffness of the material of the speaker cone 12 so that the piezoelectric actuator 30 does, not compromise the structural dynamic properties of the speaker cone 12 or the acoustic properties of the speaker 10. The thickness of the piezoelectric actuator 30 is such that it will still exert actuation to the speaker cone 12 without locally stiffening the speaker cone 12. For example, a typical speaker cone 12 made of a paperboard/cardboard type material with a thickness on the order of 30-40 thousandths of an inch may be driven by a PZT 5-A type piezoelectric actuator having a thickness in the range of between 5 and 10 thousandths of an inch. If the piezoelectric actuator 30 is thicker, it will stiffen the speaker cone 12 locally, making the piezoelectric actuator 30 less efficient. Finite element and boundary element analysis can be used to optimize the specific location of the piezoelectric actuator 30 within the geometry of a specific speaker cone 12.

As described above, and as shown in FIGS. 2 and 3, at least one piezoelectric actuator 30 is secured to the speaker cone 12. In the presently preferred embodiment, at least two and preferably four such piezoelectric actuators 30 are secured to the speaker cone 12 at predetermined spaced locations either on a surface of the cone 12 or embedded within the material of the cone 12. It is preferred that four such piezoelectric actuators 30 be secured to the speaker cone 12 to provide sufficient actuation authority although more or less piezoelectric actuators 30 may be used. If desired, different types of piezoelectric actuators 30 may be employed at different locations of the speaker cone 12. Each of the piezoelectric actuators 30 is suitably electrically connected to receive the same audio frequency drive signal which is delivered to the windings of the voice coil 14. The piezoelectric actuators 30 convert the electrical input of the audio frequency drive signal into mechanical energy to move the speaker cone 12.

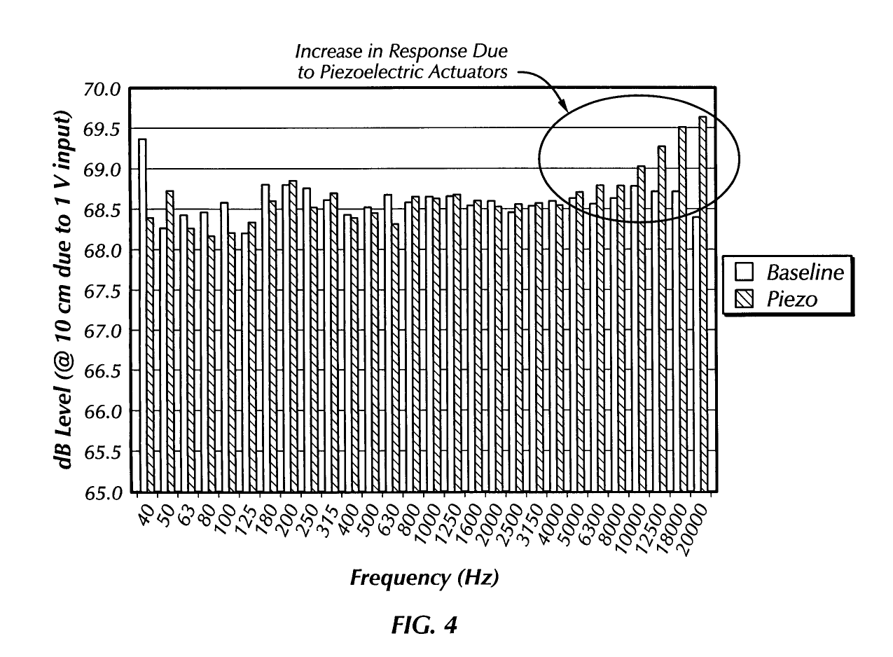

FIG. 4 is a graphic representation of the results obtained from a speaker 10 of the type shown in FIG. 2 which includes four piezoelectric actuators 30. Notice that the piezoelectric actuators 30 extend the response of the woofer-type speaker 10 at the higher end of the audio frequency range providing higher sound pressure levels at frequencies (above 5 KHz) where the speaker could not otherwise provide sufficient sound pressure. The actual response of the speaker 10 may be optimized by modifying the number and location of the piezoelectric actuators 30 on the speaker cone 12. FIG. 4 further demonstrates that minimal distortion is introduced by the piezoelectric actuators 30 in the lower frequency range.

An audio transformer 32 (shown in phantom on FIG. 2) may also be provided. The audio transformer 32 is capable of converting a received audio frequency drive signal, typically a low voltage, high current signal, from an audio amplifier (such as a home theater or car audio amplifier) to a high voltage, low current signal to be applied to the piezoelectric actuators 30. It is known that motion of piezoelectric materials is directly related to the voltage (not the current) supplied. Accordingly, an additional device, such as the audio transformer 32, while not required, can dramatically increase the output of the piezoelectric actuators 30. In the preferred embodiment, the audio transformer 32 is a Jensen transformer model JT-VX-16 which has a roll off frequency above 3 KHz and a 6:1 step up ratio meaning for every 1 volt input it delivers 6 volts output. A conventional household transformer or narrow-band transformer is not preferred because it will not provide a uniform output over an extended frequency range in order to provide a meaningful response. An additional benefit of using the audio transformer 32 in series with the piezoelectric actuators 30 is that the transformer 32 introduces a resistive load which facilitates the use of a conventional audio amplifier generally designed to drive a resistive load, as opposed to the capacitive loads typical of a piezoelectric actuator 30. Typical voice coils 14 have a resistance on the order of two, four or eight ohms and are referred to as two, four or eight ohm speakers respectively. If an audio transformer 30 is not used, a simple resistor can be used in series with the piezoelectric actuators 30 to bring the electrical impedence in the range of a typical voice coil 14.

If desired, and typically in the case of high end speakers, the piezoelectric actuators 30 can be driven out of phase by switching the positive and negative leads of the piezoelectric actuators 30. The combination of driving the piezoelectric actuators 30 out of phase and selecting the location of the individual piezoelectric actuators 30 on the speaker cone 12 may result in a smoother, less peaky, less resonant, response. The overall sound pressure level may be slightly reduced in the frequency range where the piezoelectric actuators 30 are driven out of phase.

In an alternate embodiment, the piezoelectric actuators 30 may be applied to some other structure of the speaker 10. As shown in phantom on FIG. 2, one or more piezoelectric actuators 30′ may be secured to the dust cap 18. Alternatively, the one or more piezoelectric actuators 30′ may be secured to an external structure or the housing or baffle of the speaker (not shown). In a further embodiment, one or more piezoelectric actuators 30 may be secured to the speaker cone 12 and one or more piezoelectric actuators 30′ may be secured to the dust cap 18. The piezoelectric actuators 30′ may be secured to the dust cap 18 by bonding the piezoelectric actuators 30′ to a surface of the dust cap 18 or by embedding or integrating the piezoelectric actuators 30′ into the material of the dust cap 18.

The cost of the piezoelectric actuators 30 is minimal with respect to the rest of the speaker system. Typically, the cost of adding one or more piezoelectric actuators 30 is less than the cost of adding a separate tweeter cone or tweeter to the speaker 10. Additionally, the weight added by the piezoelectric actuators 30 is well below the weight of an additional speaker, such as a tweeter. The integration of the piezoelectric actuators 30 directly into the manufacture of the speaker cone 12 provides substantial advantages and flexibility in speaker design.

The addition of one or more piezoelectric actuators 30 to a speaker 10 permits the use of a single speaker to cover substantially the entire audio frequency range. In this manner, the use of additional speakers, such as tweeters, to cover the higher frequencies of the audio frequency range can be avoided. If desired, the piezoelectric actuators 30 may be positioned so they are concealed from a viewer to thereby avoid detracting from the appearance of the speaker 10. The piezoelectric actuators 30 do not require complicated filtering or cross over functions which would be required if a separate tweeter speaker was employed. The capacitive nature of the piezoelectric actuators 30 is very conducive to making audio drive signals stable at the higher frequencies of the audio frequency range. Further, a speaker 10 in accordance with the present invention including one or more piezoelectric actuators 30 provides greater ambient and spacious sound due to the complex radiation patterns created by actuating the higher order modes of the audio frequency range as described above.

From the foregoing it can be seen that the present invention comprises the addition of one or more piezoelectric actuators 30 to a woofer or mid range speaker in order to substantially improve speaker performance, particularly at the higher frequencies of the audio frequency range. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An improved audio frequency speaker comprising:
a speaker cone suspended for movement to generate air displacement;
a voice coil having at least one winding attached to the cone; and
a magnet having a magnetic field, the magnetic being located such that at least a portion of the coil is within the magnetic field to thereby cause the coil and the cone to move when a current from an audio frequency drive signal flows through the coil winding,
wherein the improvement comprises at least one piezoelectric actuator secured to the cone and adapted to receive the audio frequency drive signal, the at least one piezoelectric actuator moving the cone at least at higher order frequencies of the audio frequency range to thereby enhance the performance range of the speaker at the higher order frequencies so that a single speaker covers the entire audio frequency range.

2. The improved speaker as recited in claim 1 wherein the at least one piezoelectric actuator is bonded to a surface of the cone.

3. The improved speaker as recited in claim 1 wherein the at least one piezoelectric actuator is integrated into the material of the cone.

4. The improved speaker as recited in claim 1 wherein the at least one piezoelectric actuator comprises one of a piezoelectric fiber and a piezoelectric plate.

5. The improved speaker as recited in claim 4 wherein the piezoelectric plate comprises a piezoceramic plate.

6. The improved speaker as recited in claim 5 wherein the piezoceramic plate comprises one of a bare piezoceramic plate and a packaged piezoceramic plate.

7. The improved speaker as recited in claim 1 wherein the stiffness of the piezoelectric actuator is similar to the stiffness of the cone.

8. The improved speaker as recited in claim 1 wherein at least two piezoelectric actuators are secured to the cone, the two piezoelectric actuators being driven out of phase.

9. The improved speaker as recited in claim 1 further comprising a plurality of piezoelectric actuators secured to the cone at spaced locations.

10. The improved speaker as recited in claim 9 wherein the plurality of piezoelectric actuators comprises 4 piezoelectric actuators.

11. The improved speaker as recited in claim 1 further comprising an audio transformer for increasing the voltage of the audio frequency drive signal prior to receipt of the drive signal by the at least one piezoelectric actuator.

12. An improved audio frequency speaker comprising:
a speaker cone suspended for movement to generate air displacement;
a voice coil having at least one winding attached to the cone;
a magnet having a magnetic field, the magnet being located such that at least a portion of the coil is within the magnetic field to thereby cause the coil and the cone to move when a current from an audio frequency drive signal flows through the coil winding; and
a dust cap covering at least a portion of the speaker cone,
wherein the improvement comprises at least one piezoelectric actuator secured to the dust cap and adapted to receive the audio frequency drive signal, the at least one piezoelectric actuator moving the dust cap and the cone at least at higher order frequencies of the audio frequency range to thereby enhance the performance range of the speaker at the higher order frequencies so that a single speaker covers the entire audio frequency range.

13. The improved speaker as recited in claim 12 wherein the at least one piezoelectric actuator is bonded to the dust cap.

14. The improved speaker as recited in claim 12 wherein the at least one piezoelectric actuator is integrated into the material of the dust cap.

15. The improved speaker as recited in claim 12 further including a plurality of piezoelectric actuators wherein at least one of the piezoelectric actuators is secured to the cone and at least one of the piezoelectric actuators is secured to the dust cap.
